(19) United States
(12) Patent Application Publication
(10) Pub. No.: US 2017/0053437 A1
(43) Pub. Date: Feb. 23, 2017

(54) METHOD AND APPARATUS FOR POSITIONING NAVIGATION IN A HUMAN BODY BY MEANS OF AUGMENTED REALITY BASED UPON A REAL-TIME FEEDBACK

(71) Applicants: JIan YE, Shanghai (CN); Han GAO, Shanghai (CN); Lingling QIU, Shanghai (CN)

(72) Inventors: Jian YE, Shanghai (CN); Han GAO, Shanghai (CN); Li WAN, Shanghai (CN); Lingling QIU, Shanghai (CN)

(21) Appl. No.: 15/292,947

(22) Filed: Oct. 13, 2016

(30) Foreign Application Priority Data
Jun. 6, 2016 (CN) 201610395355.4
Aug. 3, 2016 (CN) 201610629122.6

(51) Int. Cl. G06T 17/20; G06T 19/00; G06T 7/00

(52) U.S. Cl. CPC G06T 17/20; G06T 7/0012; G06T 19/006

(57) ABSTRACT

Disclosed are a method and apparatus for positioning navigation in a human body by means of augmented reality based upon a real-time feedback, the method includes: obtaining a first 3D reconstructed image of a target object according to medical image data corresponding to properties of the target object, a medical database system, and/or a first set of user instructions; generating image transformation parameters according to information extracted from feature points from the target object acquired by an AR device, and the first 3D reconstructed image; and to adjust the first 3D reconstructed image according to the image transformation parameters to obtain a second 3D reconstructed image, and displaying in a real-time fashion the second 3D reconstructed image on the AR device.

### CROSS-REFERENCE TO RELATED APPLICATION

This application claims priority to Chinese Patent Application No. 201610395355.4, filed on Jun. 6, 2016, and Chinese Patent Application No. 201610629122.6, filed on Aug. 3, 2016, both of which are hereby incorporated by reference in their entireties.

### FIELD

The present disclosure relates to the field of computer technologies, and particularly to a method and apparatus for positioning navigation in a human body by means of augmented reality based upon a real-time feedback.

### BACKGROUND

A lot of medial manipulations in existing clinical tasks are performed based upon accurate anatomic positioning, for example, various puncturing manipulations are still performed manually by a doctor based upon anatomic landmark and experience, thus resulting in inaccurate positioning, and consequently some medical operational risks.

In order to address the problem above, 3D visualization software, e.g., Osirix, 3DSlicer, ImageJ, etc., or some 3D reconstruction software configured specifically or a navigation system, has been widely applied in the existing clinical tasks, where respective parts of the body of a patient are 3D reconstructed using the software for preoperative observation so that the doctor can determine the conditions of the respective parts of the body of the patient.

### SUMMARY

The disclosure provides a method and apparatus for positioning navigation in a human body by means of augmented reality based upon a real-time feedback so as to address such a technical problem in the prior art that the 3D reconstructed medical image is not correlated directly with the physical body of the patient, and the doctor cannot plan manipulations in accordance with the physical tissue of the patient, so that the operation cannot be adjusted in a real-time fashion to the physical body of the patient on the spot.

In an aspect, some embodiments of the disclosure provide a method for positioning navigation in a human body by means of augmented reality based upon a real-time feedback, the method includes:

generating an initial 3D reconstructed image of a target object according to medical image data corresponding to properties of the target object;

adjusting the initial 3D reconstructed image according to a medical database system, and/or a first set of user instructions given by a user to obtain a first 3D reconstructed image of the target object;

generating image transformation parameters according to information extracted from feature points from the target object acquired by an Augmented Reality (AR) device, and the first 3D reconstructed image of the target object, wherein the first 3D reconstructed image is generated according to the medical image data of, and the AR device is transparent, and can permit the user to see the target object through the AR device; and

adjusting the first 3D reconstructed image according to the image transformation parameters to obtain a second 3D reconstructed image, wherein feature points in the second 3D reconstructed image displayed on the AR device are overlapped with physical feature points of the target object seen by the user through the AR device.

In another aspect, some embodiments of the disclosure provide an apparatus for positioning navigation in a human body by means of augmented reality based upon a real-time feedback, the apparatus includes:

an image generating unit configured to generate an initial 3D reconstructed image of a target object according to medical image data corresponding to properties of the target object; and to adjust the initial 3D reconstructed image according to a medical database system, and/or a first set of user instructions given by a user to obtain a first 3D reconstructed image of the target object;

an image transformation parameter generating unit configured to generate image transformation parameters according to information extracted from feature points from the target object acquired by an Augmented Reality (AR) device, and the first 3D reconstructed image of the target object, wherein the first 3D reconstructed image is generated according to the medical image data, and the AR device is transparent, and thus can permit the user to see the target object through the AR device; and

an adjusting unit configured to adjust the first 3D reconstructed image according to the image transformation parameters to obtain a second 3D reconstructed image, wherein feature points in the second 3D reconstructed image displayed on the AR device are overlapped with physical feature points of the target object seen by the user through the AR device.

### BRIEF DESCRIPTION OF THE DRAWINGS

In order to explicate the technical solutions according to the embodiments of the disclosure, the drawings to which a description of the embodiments art refers will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a flow chart of a method for positioning navigation in a human body by means of augmented reality based upon a real-time feedback according to some embodiments of the disclosure;

FIG. 2 is a schematic diagram of parameter adjustment based upon a parameter adjusting system according to some embodiments of the disclosure;

FIG. 3 is a schematic diagram of parameter adjustment based upon a library of function blocks according to some embodiments of the disclosure;

FIG. 4 is a schematic diagram of information acquisition by sensors according to some embodiments of the disclosure;

FIG. 5 is a schematic diagram of information acquisition by a camera according to some embodiments of the disclosure;

FIG. 6 is a detailed flow chart of a method for positioning navigation in a human body by means of augmented reality based upon a real-time feedback according to some embodiments of the disclosure; and

FIG. 7 is a schematic diagram of an apparatus for positioning navigation in a human body by means of augmented reality based upon a real-time feedback according to some embodiments of the disclosure;

### DETAILED DESCRIPTION OF THE EMBODIMENTS

In order to explicate the objects, technical solutions, and advantages of the disclosure, the disclosure will be described below in further details with reference to the drawings, and apparently the embodiments described below are only a part but not all of the embodiments of the disclosure. Based upon the embodiments stated in the disclosure, all the other embodiments which can occur to those skilled in the art without any inventive effort shall fall into the scope of the disclosure.

The embodiments of the disclosure will be described below in further details with reference to the drawings.

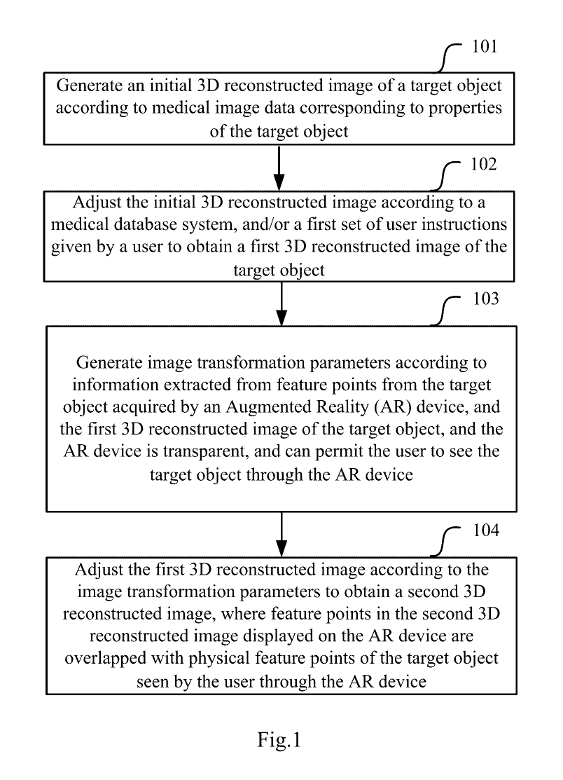

As illustrated in FIG. 1, a method for positioning navigation in a human body by means of augmented reality based upon a real-time feedback according to some embodiments of the disclosure includes:

The step 101 is to generate an initial 3D reconstructed image of a target object according to medical image data corresponding to properties of the target object;

The step 102 is to adjust the initial 3D reconstructed image according to a medical database system, and/or a first set of user instructions given by a user to obtain a first 3D reconstructed image of the target object;

The step 103 is to generate image transformation parameters according to information extracted from feature points from the target object acquired by an Augmented Reality (AR) device, and the first 3D reconstructed image of the target object, where the first 3D reconstructed image is generated according to the medical image data, and the AR device is transparent, and thus can permit the user to see the target object through the AR device; and

The step 104 is to adjust the first 3D reconstructed image according to the image transformation parameters to obtain a second 3D reconstructed image, where feature points in the second 3D reconstructed image displayed on the AR device are overlapped with physical feature points of the target object seen by the user through the AR device.

In the embodiments of the disclosure, the information can be acquired by the Augmented Reality (AR) device, but in a real application, the information can alternatively be acquired by another general-purpose display device, e.g., any display device displaying a 2D or 3D image, Virtual Reality (VR)/3D/2D glasses, a VR/3D/2D display device, a VR/2D/3D wearable device, etc. The target object refers to the body of a patient, or some part of the body of the patient (e.g., the head, the arm, the upper half of the body, etc.), and the patient can be lying on an operation table, and then a doctor can have the 3D reconstructed image of the target image displayed on the AR device, for example, if the head of the patient needs to be observed, then the 3D reconstructed image of the head of the patient will be displayed on the AR device; and there is a camera installed on the AR device, and the body of the patient can be seen through the camera. Of course, if the AR device is transparent and wearable (for example, the AR device is AR glasses), then the doctor can wear the AR device directly, and then observe the patient through the AR device; and the doctor can see the body of the patient through the AR device, as well as the 3D reconstructed image on the AR device. The doctor performing an operation can adjust the location of the AR device to locate an appropriate location so that the 3D reconstructed image displayed on the AR device overlaps with the target object seen by the user through the AR device. Taking the head as an example, the doctor can see the 3D reconstructed image on the AR device, and then move the location of the AR device to locate an appropriate location so that the head of the patient seen by the user through the AR device overlaps with the 3D reconstructed image of the head on the AR device, hence it is convenient for the doctor to observe the internal structure of the head of the patient by watching the 3D reconstructed image on the AR device.

The 3D reconstructed image on the AR device can be registered automatically with the target object in the step 101 to the step 104 above of the disclosure. That is, if the location of the AR device is changed, then the angle and the size of the 3D reconstructed image displayed on the AR device can be transformed automatically so that the target object seen by the user through the AR device is overlapped with the transformed 3D reconstructed image in real-time fashion.

In the step 101 above, firstly the initial 3D reconstructed image of the target object is generated according to the medical image data, where the medical image data can be Computed Tomography (CT), Magnetic Resonance Imaging (MM), Positron Emission Computed Tomography (PET), or other image data, or image data into which one or more of the image data are fused, and the initial 3D reconstructed image can be obtained through 3D modeling.

In the step 102 above, the initial 3D reconstructed image is adjusted according to the medical database system, and/or the first set of user instructions to obtain the first 3D reconstructed image of the target object.

Here the medical database system refers to a medical information database by means of statistics, which can be updated with medical data of the current patient, and with which the 3D reconstructed data can be optimized using historical optimum results, historical means and variances, and other statistical information, so the optimized initial reconstructed image can be utilised as the first 3D reconstructed image.

Two approaches in which the initial 3D reconstructed image is adjusted according to the medical database system and/or the first set of user instructions to obtain the first 3D reconstructed image of the target object will be described below in details.

In a first approach, the initial 3D reconstructed image is adjusted based upon a preset parameter adjusting system.

The first step is to receive a first parameter adjustment instruction given by the user through the preset parameter adjusting system configured to visually display 3D reconstructed image information; and

The second step is to adjust the initial 3D reconstructed image according to the first parameter adjustment instruction to obtain the first parameter adjusting system of the target object, or adjust the initial 3D reconstructed image according to the first parameter adjustment instruction and the medical database system and/or the first set of instructions to obtain the first parameter adjusting system of the target object.

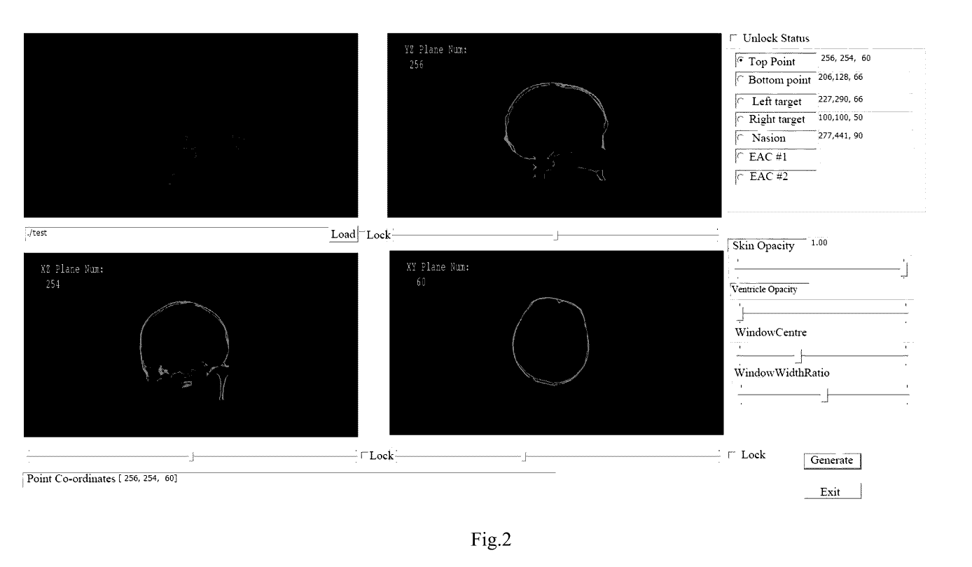

A particular implementation of the first approach above will be described below by an example. Reference will be made to FIG. 2 which is a schematic diagram of parameter adjustment based upon a parameter adjusting system according to some embodiments of the disclosure.

In FIG. 2, the top-left first 3D image is the initial 3D reconstructed image, and if this 3D reconstructed image needs to be adjusted, then it will be modified directly through the parameter adjusting system as illustrated in FIG. 2. For example, it can be adjusted through the parameter adjusting section in the right part of FIG. 2, and in another example, if a path for puncture in the head needs to be located, then the user (e.g., a doctor) will empirically or by some rules define some reference points on the top-right image, and the two images in the lower row, and then click on the “Generate” button at the bottom-right corner in FIG. 2 to obtain the adjusted first 3D reconstructed image, so that the adjusted first 3D reconstructed image includes thereon additional information about the path for puncture, etc.

In the first approach, the user (e.g., a doctor) can fine-tune the parameters on the parameter adjusting system illustrated in FIG. 2 as per experience of the user so as to obtain desirable result of the user, and in this approach, human-machine interaction can be performed so that great convenience can be obtained by the doctor to conduct pre-operative precise operation during the surgery.

Albeit in the first approach, the doctor can be guided conveniently prior to and during the surgery, a problem may still arise, that is, the parameter adjusting system illustrated in FIG. 2 is designed in advance, and once this system is created, it means that the parameters can be adjusted only using the functions provided in the system, so that varying demands of different users may not be met. For example, the doctor intends to have a vascular image displayed on the finally displayed 3D reconstructed image, but this function is not created in advance in the parameter adjusting system, so that the doctor cannot adjust the 3D reconstructed image through the system illustrated in FIG. 2 to obtain desirable display effect.

In view of this, some embodiments of the disclosure further provide another approach in which the initial 3D reconstructed image is adjusted, specified as follows:

In a second approach, the initial 3D reconstructed image is adjusted based upon function blocks selected by the user from a pre-created library of function blocks.

The first step is to determine a second parameter adjustment instruction according to function blocks selected by the user from a pre-created library of function blocks, and a mode they connect established by the user for the selected function blocks. Each function block in the pre-created library of function blocks is configured to implement an image processing method, or a combination of image processing methods, and all the function blocks in the pre-created library of function blocks can be connected under some pre-defined rules; the image processing method includes at least one of image processing, pattern recognition, computer vision and all processing that can be manipulated upon image and/or image sequences; and

The second step is to adjust the initial 3D reconstructed image according to the second parameter adjustment instruction to obtain the first 3D reconstructed image of the target object, or adjust the initial 3D reconstructed image according to the second parameter adjustment instruction and the medical database system and/or the first set of user instructions to obtain the first 3D reconstructed image of the target object.

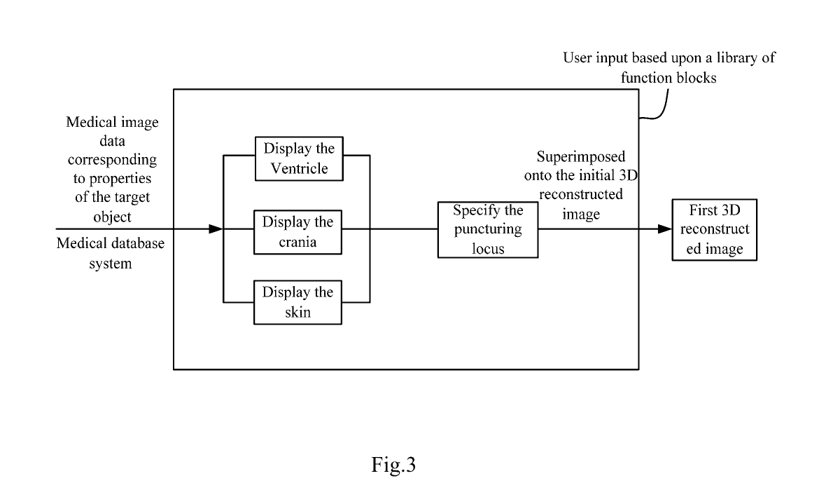

A particular implementation of the second approach above will be described below by an example. Reference will be made to FIG. 3 which is a schematic diagram of parameter adjustment based upon a library of function blocks according to some embodiments of the disclosure.

In the second approach, the initial 3D reconstructed image is adjusted in accordance with the library of function blocks so as to obtain the desirable first 3D reconstructed image. Particularly the library of function blocks includes a number of function blocks, each of which is configured to implement an image processing method, or a combination of image processing methods, and all the function blocks in the pre-created library of function blocks can be connected under some pre-defined rules. The image processing method includes at least one of image processing, pattern recognition, computer vision and all processing that can be manipulated upon image and/or image sequences. Particularly they can be connected serially, in parallel, in a feedback loop, etc., but the embodiments of the disclosure will not be limited thereto.

Referring to FIG. 3, for example, if the ventricle needs to be further displayed in the initial 3D reconstructed image, then a function block for displaying ventricle will be added; if the crania needs to be further displayed, then a function block for displaying crania will be added; if the skin needs to be further displayed, then a function block for displaying skin will be added; and if a locus for puncture needs to be further specified, then a function block for specifying locus for puncture will be added. Moreover a number of function blocks can be connected and permuted (they can be permuted in a specified sequential order in which they are performed), and after a corresponding function block is added, the corresponding function block can be further deleted flexibly and conveniently. Each function block is editable, and particularly the user can right-click on a function block so that a property dialog box is popped up, and the user can further modify and adjust the parameters of the function block using the dialog box; and after the function block is adjusted, the effect due to adjustment can be previewed immediately, hence in comparison with the first approach, the implementation of the second approach is more convenient; and can be understood and utilised by a user, especially a doctor, more easily.

Moreover in a practice, after applying a combination of function blocks, the user can further store the combination into the medical database as a processing template for reference in later use.

Moreover some embodiments of the disclosure further provide another approach for generating an initial 3D reconstructed image specified as follows:

The first step is to generate the initial 3D reconstructed image of the target object according to the medical image data, function blocks selected by the user from the pre-created library of function blocks, and a mode they connect established by the user for the selected function blocks. Each function block in the pre-created library of function blocks is configured to implement an image processing method, or a combination of image processing methods, and all the function blocks in the pre-created library of function blocks can be connected under some pre-defined rules; the image processing method includes at least one of image processing, pattern recognition, computer vision and all processing that can be manipulated upon image and/or image sequences;

The second step is to obtain a third parameter adjustment instruction according to a first set of user instructions given by the user for the selected function blocks; and

The third step is to adjust the initial 3D reconstructed image according to the medical database system and the third parameter adjustment instruction to obtain the first 3D reconstructed image of the target object.

Particularly the initial 3D reconstructed image can be obtained by following: firstly selecting the function blocks by the user from the pre-created library of function blocks, and the mode they connect established by the user for the selected function blocks, and then incorporating the medical image data from input, and the 3D reconstructed image can be adjusted in the second and third steps, that is, the user can provide instructions to the selected function blocks (that is, the user can right-click on each selected function block, so that a parameter adjustment dialog box is popped up, and the user can provide the instructions to the box so as to obtain the adjusted parameters) to obtain the third parameter adjustment instruction, and then adjust the initial 3D reconstructed image according to the medical database system and the third parameter adjustment instruction to obtain the first 3D reconstructed image of the target object.

Of course, alternatively the initial 3D reconstructed image can be adjusted directly according to the third parameter adjustment instruction to obtain the first 3D reconstructed image of the target object, or according to the third parameter adjustment instruction and the medical database system and/or the first set of user instructions to obtain the first 3D reconstructed image of the target object.

In some embodiments of the disclosure, the medical image data can be input into library of function blocks so that the medical image data is incorporated to the library of function blocks, and then the resulting 3D reconstructed image can be output.

After the first 3D reconstructed image is obtained, in order to permit the first 3D reconstructed image to be displayed appropriately on the AR device, the angle and the size of the first 3D reconstructed image will be further adjusted, so that the adjusted 3D reconstructed image displayed on the AR device can be overlapped with the target object of the patient observed by the doctor through the AR device.

In the step 103 above, the image transformation parameters are generated according to the information extracted from feature points from the target object acquired by the Augmented Reality (AR) device, and the first 3D reconstructed image of the target object. The first 3D reconstructed image is generated according to the medical image data, and the AR device is transparent, and can permit the user to see the target object through the AR device.

The AR device can acquire the information of the target object, including the information extracted from feature points, brightness, contrast, depth of field, distance, hue, chrome, edge and other information. In some embodiments of the disclosure, adjustment for the 3D reconstructed image displayed on the AR device according to the information extracted from feature points from the target object will be described by an example.

In some embodiments of the disclosure, the image transformation parameters are generated according to the information extracted from feature points from the target object, and the first 3D reconstructed image of the target object, and optionally the AR device can acquire the information extracted from feature points from the target object in at least the following two approaches:

In a first approach, the AR device scans the target object using sensors on the AR device to acquire the information extracted from feature points from the target object. The information extracted from feature points is information corresponding to feature markers.

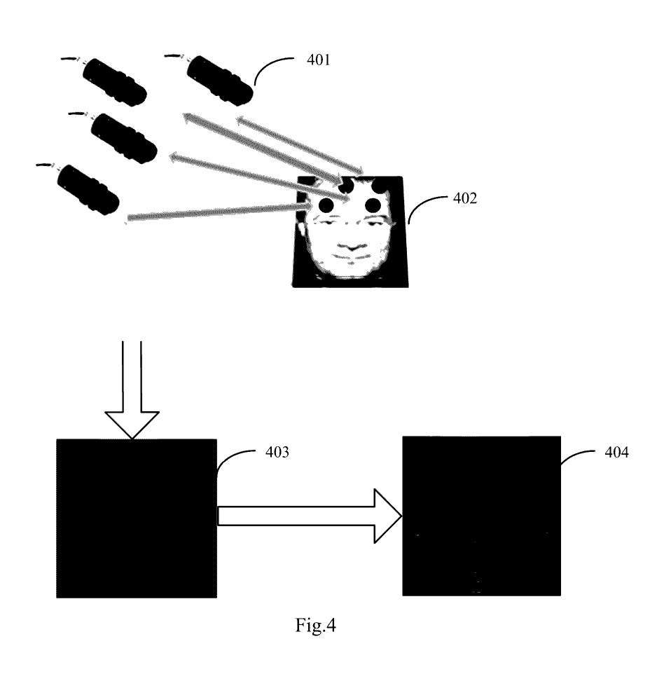

In this approach, FIG. 4 is a schematic diagram of information acquisition by a sensor according to some embodiments of the disclosure. The sensors 401 are installed inside or outside the AR device, and feature markers are installed on the target object 402 and/or anything which can indicate positions of the target object 402. The feature markers can be identified by the sensors 401, and the sensors can acquire actively or receive passively sensing information on the target object 402, so that the sensors on the AR device can acquire the information extracted from feature points from the target object. The information extracted from feature points from the target object includes information about relationship between the current locations of the doctor and the target object 402 (including the angle, the distance, the orientation, and other information), that is, the information extracted from feature points from the target object can be acquired by the sensors.

In a second approach, the AR device acquires the information extracted from feature points from the target object by photographing the target object using a camera on the AR device. The information extracted from feature points is information corresponding to preset locations on the target object.

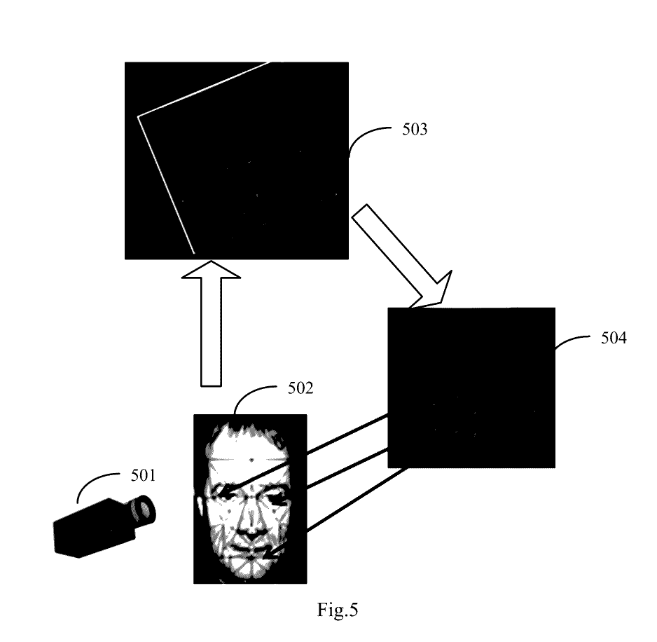

In this approach, FIG. 5 is a schematic diagram of information acquisition by a camera according to some embodiments of the disclosure. The camera 501 can be installed inside or outside the AR device, and the camera 501 can photograph the target object 502, and thus analyses, such as image processing, pattern recognition, and computer vision, on photo information as a result of photographing to obtain information about preset locations. For example, referring to FIG. 5, if the target object is the head, and the preset locations include the eyes and the nose, then the target object will be photographed using the camera on the AR device so as to obtain an image, and then a pattern of the image will be recognized to obtain location information of the eyes, the nose, and other feature points in the image, so that relationship (including the angular relationship and the distance relationship) between the current locations of the AR device and the target object can be known.

In any one of the approaches above, the information extracted from feature points from the target object can be finally acquired. The image transformation parameters can be further generated according to the information extracted from feature points from the target object acquired by the AR device, and the first 3D reconstructed image of the target object. The information extracted from feature points from the target object include relationship between locations of the doctor and the target object in and other information. Optionally the image transformation parameters can be generated according to the information extracted from feature points from the target object acquired by the AR device, and the first 3D reconstructed image of the target object by determining a feature pattern of the target object according to the information extracted from feature points; determining a rotational angle, a rotational orientation, a translational distance, and a scaling factor of the first 3D reconstructed image according to the feature pattern of the target object, and the first 3D reconstructed image of the target object; and determining the rotational angle, the rotational orientation, the translational distance, and the scaling factor as the image transformation parameters.

In this implementation, firstly the feature pattern of the target object is determined according to the information extracted from feature points from the target object, where a number of feature patterns are pre-stored. Each of the feature patterns represents a particular location relationship between the doctor and the target object; one of the pre-stored feature patterns is matched with the information extracted from feature points from the target object; and then the rotational angle, the rotational orientation, the translational distance, and the scaling factor required for the first 3D reconstructed image of the target object are determined based upon the feature pattern, and the first 3D reconstructed image, and the rotational angle, the rotational orientation, the translational distance, and the scaling factor are determined as the image transformation parameters.

In the step 104 above, the first 3D reconstructed image is adjusted according to the image transformation parameters to obtain the second 3D reconstructed image. The feature points in the second 3D reconstructed image displayed on the AR device are overlapped with the physical feature points of the target object seen by the user through the AR device

For example, referring to FIG. 4, after the information extracted from feature points from the target object 402 is acquired using the sensors 401, the image transformation parameters can be obtained based upon the information extracted from feature points and the first 3D reconstructed image 403 (i.e., the current 3D reconstructed image), and then in the step 104, the first 3D reconstructed image 403 can be adjusted according to the image transformation parameters to obtain the second 3D reconstructed image 404. The feature points in the second 3D reconstructed image are overlapped with the physical feature points of the target object seen by the user through the AR device.

In the approach above, the second 3D reconstructed image 404 is displayed as a result on the AR device, and the second 3D reconstructed image 404 is overlapped with the target object 402 seen by the doctor through the AR device. Either the AR device or the target object moves so that the target object seen by the doctor is changed (generally the changes for the angle and the distance between the target object and the AR device), then the step 101 to the step 104 will be repeated to readjust the 3D reconstructed image on the AR device so that the adjusted 3D reconstructed image keeps overlapping with the observed target object. Accordingly the method can permit the doctor to move the AR device arbitrarily on the spot during the surgery to update the 3D reconstructed image on the AR device in a real-time fashion so that the 3D reconstructed image keeps overlapping with the target object, and in this way, the doctor can improve the accuracy and the efficiency of the surgery by observing the internal structure of the target object by watching the 3D reconstructed image on the AR device.

The approach illustrated in FIG. 5 where the information of the target object is obtained by the camera is similar to the approach illustrated in FIG. 4 in that the image transformation parameters can be obtained according to the acquired information of the target object 502, and the first 3D reconstructed image 503, and then the first 3D reconstructed image 503 can be adjusted according to the image transformation parameters to obtain the second 3D reconstructed image 504 overlapped with the target object 502.

It shall be noted that the step 101 through the step 104 in the method above can be performed particularly by a processor in the AR device, that is, the processor is embedded in the AR device; or those steps can be performed particularly by a third-party Personal Computer (PC), that is, the AR device is only responsible for acquiring and transmitting the information extracted from feature points from the target object to the PC, and the PC transforms the first 3D reconstructed image into the second 3D reconstructed image, and then transmits the second 3D reconstructed image to the AR device for displaying thereon.

If the step 101 through the step 104 in the method above are performed by the PC, then the PC will receive the information extracted from feature points from the target object acquired by the AR device; and then adjust the first 3D reconstructed image according to the image transformation parameters to obtain the second 3D reconstructed image, and further transmit the second 3D reconstructed image to the AR device, so that the second 3D reconstructed image is displayed on the AR device.

In the method above, the doctor can move the AR device arbitrarily, and the 3D reconstructed image on the AR device can be adjusted in a real-time fashion, so that the 3D reconstructed image displayed on the AR device always overlaps with the target object seen by the user through the AR device.

In a practice, if the doctor finds that the 3D reconstructed image that is automatically adjusted is not totally registered with the target object, or the doctor intends to observe the 3D reconstructed image in an alternative way (e.g., zooming in, rotating the 3D reconstructed image), then the doctor will intend to send an instruction manually to the AR device to adjust the 3D reconstructed image accordingly, and in view of this, the 3D reconstructed image on the AR device can be adjusted as follows in some embodiments of the disclosure:

Image adjustment parameters are generated according to a second set of user instructions; the second 3D reconstructed image is adjusted according to the image adjustment parameters to obtain a third 3D reconstructed image; and the third 3D reconstructed image is displayed on the AR device.

Stated otherwise, the second 3D reconstructed image registered with the target object is currently displayed on the AR device, and at this time, the doctor can disable the automatic registration, so that the 3D reconstructed image will not be registered in a real-time fashion any longer, and then the doctor can send an instruction to the AR device, for example, via voice, by moving his or her head, making a gesture, or adjusting manually a button on the AR device, etc. For example, the doctor notifies the AR device of his or her desirable action via voice “Zoom in by a factor of 2”, “Rotate counterclockwise by 30 degrees”, etc., and the AR device receiving the voice instruction adjusts the second 3D reconstructed image accordingly to obtain the third 3D reconstructed image, and displays the third 3D reconstructed image on the AR device, or the AR device sends the received voice instruction to the PC, and the PC adjusts the second 3D reconstructed image accordingly to obtain the third 3D reconstructed image, and then transmits the third 3D reconstructed image to the AR device for display. In this way, the doctor can control the 3D reconstructed image to be displayed on the AR device.

In the embodiments of the disclosure, firstly the first 3D reconstructed image of the target object is obtained according to the medical image data, the medical database system, and/or the first set of user instructions, and then the image transformation parameters are generated according to the information extracted from feature points from the target object acquired by the AR device, and the first 3D reconstructed image of the target object, and the first 3D reconstructed image is adjusted according to the image transformation parameters to obtain the second 3D reconstructed image, so that the feature points in the second 3D reconstructed image are overlapped with the physical feature points of the target object seen by the user through the AR device, and the second 3D reconstructed image is displayed on the AR device. In the embodiments of the disclosure, the 3D reconstructed image can be displayed on the AR device, and the 3D reconstructed image can be adjusted in a real-time fashion according to the information extracted from feature points from the target object, so that the 3D reconstructed image watched by the doctor on the AR device is overlapped with the target object watched by the user through the AR device, and even if the AR device or the target object moves, the 3D reconstructed image on the AR device can be adjusted in a real-time fashion, thus greatly improving the accuracy and the efficiency of the doctor during the surgery.

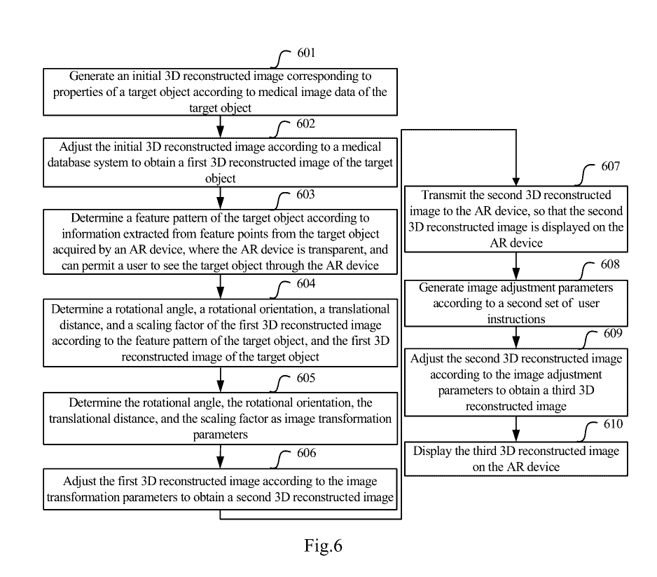

As illustrated in FIG. 6 which is a detailed flow chart of a method for positioning navigation in a human body by means of augmented reality based upon a real-time feedback according to some embodiments of the disclosure, the method includes:

The step 601 is to generate an initial 3D reconstructed image of a target object according to medical image data corresponding to properties of the target object;

The step 602 is to adjust the initial 3D reconstructed image according to a medical database system to obtain a first 3D reconstructed image of the target object;

The step 603 is to determine a feature pattern of the target object according to information extracted from feature points from the target object acquired by an AR device. The AR device is transparent, and can permit a user to see the target object through the AR device;

The step 604 is to determine a rotational angle, a rotational orientation, a translational distance, and a scaling factor of the first 3D reconstructed image according to the feature pattern of the target object, and the first 3D reconstructed image of the target object;

The step 605 is to determine the rotational angle, the rotational orientation, the translational distance, and the scaling factor as image transformation parameters;

The step 606 is to adjust the first 3D reconstructed image according to the image transformation parameters to obtain a second 3D reconstructed image;

The step 607 is to transmit the second 3D reconstructed image to the AR device, so that the second 3D reconstructed image is displayed on the AR device;

Here the second 3D reconstructed image displayed on the AR device is overlapped with the target object seen by the user through the AR device;

The step 608 is to generate image adjustment parameters according to a second set of user instructions;

The step 609 is to adjust the second 3D reconstructed image according to the image adjustment parameters to obtain a third 3D reconstructed image; and

The step 610 is to display the third 3D reconstructed image on the AR device.

Here the third 3D reconstructed image displayed on the AR device is overlapped with the target object seen by the user through the AR device.

In the embodiment of the disclosure, firstly the first 3D reconstructed image of the target object is obtained according to the medical image data, the medical database system, and/or the first set of user instructions, and then the image transformation parameters are generated according to the information extracted from feature points from the target object acquired by the AR device, and the first 3D reconstructed image of the target object, and the first 3D reconstructed image is adjusted according to the image transformation parameters to obtain the second 3D reconstructed image, so that the feature points in the second 3D reconstructed image are overlapped with the physical feature points of the target object seen by the user through the AR device, and the second 3D reconstructed image is displayed on the AR device. In the embodiments of the disclosure, the 3D reconstructed image can be displayed on the AR device, and the displayed 3D reconstructed image can be adjusted in a real-time fashion according to the information extracted from feature points from the target object, so that the 3D reconstructed image watched by the doctor on the AR device is overlapped with the target object seen by the user through the AR device, and even if the AR device or the target object moves, the 3D reconstructed image on the AR device can be adjusted in a real-time fashion, thus greatly improving the accuracy and the efficiency of the doctor during the surgery.

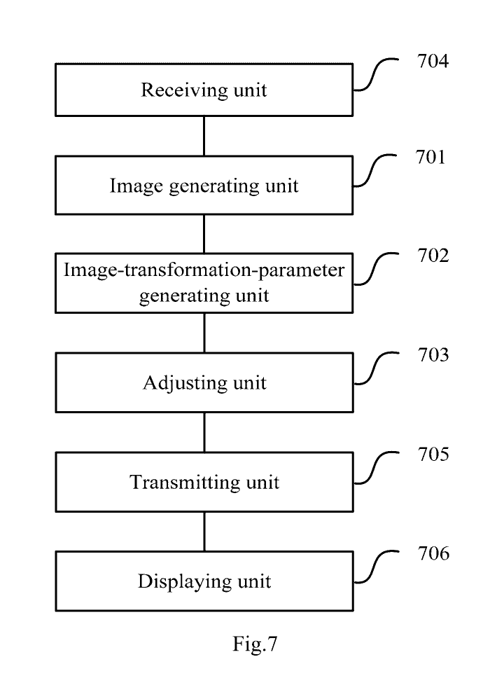

Based upon the same technical idea, as illustrated in FIG. 7, some embodiments of the disclosure further provide an apparatus for positioning navigation in a human body by means of augmented reality based upon a real-time feedback, the apparatus includes:

An image generating unit 701 is configured to generate an initial 3D reconstructed image of a target object according to medical image data corresponding to properties of the target object; and to adjust the initial 3D reconstructed image according to a medical database system, and/or a first set of user instructions given by a user to obtain a first 3D reconstructed image of the target object;

An image-transformation-parameter generating unit 702 is configured to generate image transformation parameters according to information extracted from feature points from the target object acquired by an Augmented Reality (AR) device, and the first 3D reconstructed image of the target object. The first 3D reconstructed image is generated according to the medical image data, and the AR device is transparent, and can permit the user to see the target object through the AR device; and

An adjusting unit 703 is configured to adjust the first 3D reconstructed image according to the image transformation parameters to obtain a second reconstructed image in which feature points are overlapped with physical feature points of the target object seen by the user through the AR device.

Optionally the image-transformation-parameter generating unit 702 is configured:

To determine a feature pattern of the target object according to the information extracted from feature points;

To determine a rotational angle, a rotational orientation, a translational distance, and a scaling factor of the first 3D reconstructed image according to the feature pattern of the target object, and the first 3D reconstructed image of the target object; and

To determine the rotational angle, the rotational orientation, the translational distance, and the scaling factor as the image transformation parameters.

Optionally the apparatus further includes a receiving unit 704 configured:

To receive the information extracted from feature points from the target object acquired by the AR device; and

The apparatus further includes a transmitting unit 705 configured:

To transmit the second 3D reconstructed image to the AR device, so that the second 3D reconstructed image is displayed on the AR device.

Optionally the AR device scans the target object using sensors on the AR device to acquire the information extracted from feature points from the target object. The information extracted from feature points is information corresponding to feature markers; or

The AR device acquires the information extracted from feature points from the target object by photographing the target object using a camera on the AR device. The information extracted from feature points is information corresponding to preset locations on the target object.

Optionally the image-transformation-parameter generating unit 702 is further configured to generate image adjustment parameters according to a second set of user instructions;

The adjusting unit is further configured to adjust the second 3D reconstructed image according to the image adjustment parameter to obtain a third 3D reconstructed image; and

The apparatus further includes a displaying unit 706 configured to display the third 3D reconstructed image on the AR device.

Optionally the image generating unit 701 is configured:

To receive a first parameter adjustment instruction given by the user through a preset parameter adjusting system configured to visually display 3D reconstructed image information; and

To adjust the initial 3D reconstructed image according to the first parameter adjustment instruction to obtain the first 3D reconstructed image of the target object, or adjust the initial 3D reconstructed image according to the first parameter adjustment instruction and the medical database system and/or the first set of user instructions to obtain the first 3D reconstructed image of the target object.

Optionally the image generating unit 701 is configured:

To determine a second parameter adjustment instruction according to function blocks selected by the user from a pre-created library of function blocks, and a mode they connect established by the user for the selected function blocks. Each function block in the pre-created library of function blocks is configured to implement an image processing method, or a combination of image processing methods, and all the function blocks in the pre-created library of function blocks can be connected under some pre-defined rules; the image processing method includes at least one of image processing, pattern recognition, computer vision and all processing that can be manipulated upon image and/or image sequences; and

To adjust the initial 3D reconstructed image according to the second parameter adjustment instruction to obtain the first 3D reconstructed image of the target object, or adjust the initial 3D reconstructed image according to the second parameter adjustment instruction and the medical database system and/or the first set of user instructions to obtain the first 3D reconstructed image of the target object.

Optionally the image generating unit 701 is configured:

To generate the initial 3D reconstructed image of the target object according to the medical image data, function blocks selected by the user from the pre-created library of function blocks, and a mode they connect established by the user for the selected function blocks. Each function blocks in the pre-created library of function blocks is configured to implement an image processing method, or a combination of image processing methods, and all the function modules in the pre-created library of function blocks can be connected under some pre-defined rules; the image processing method includes at least one of image processing, pattern recognition, computer vision and all processing that can be manipulated upon image and/or image sequences;

To obtain a third parameter adjustment instruction according to a first set of user instructions given by the user to the selected function blocks; and

To adjust the initial 3D reconstructed image according to the third parameter adjustment instruction to obtain the first 3D reconstructed image of the target object, or adjust the initial 3D reconstructed image according to the third parameter adjustment instruction the medical database system and/or the first set of user instructions to obtain the first 3D reconstructed image of the target object.

Based upon the same technical idea, some embodiments of the disclosure further provide an apparatus for positioning navigation in a human body by means of augmented reality based upon a real-time feedback. The apparatus includes one or more processors and a memory unit communicably connected with the processor for storing instructions executed by the processor. The execution of the instructions by the processor causes the processor to perform the aforementioned method for positioning navigation in a human body by means of augmented reality based upon a real-time feedback.

In the embodiments of the disclosure, firstly the first 3D reconstructed image of the target object is obtained according to the medical image data, the medical database system, and/or the first set of user instructions, and then the image transformation parameters are generated according to the information extracted from feature points from the target object acquired by the AR device, and the first 3D reconstructed image of the target object, and the first 3D reconstructed image is adjusted according to the image transformation parameters to obtain the second 3D reconstructed image, so that the feature points in the second 3D reconstructed image are overlapped with the physical feature points of the target object seen by the user through the AR device, and the second 3D reconstructed image is displayed on the AR device. In the embodiments of the disclosure, the 3D reconstructed image can be displayed on the AR device, and the displayed 3D reconstructed image can be adjusted in a real-time fashion according to the information extracted from feature points from the target object, so that the 3D reconstructed image watched by a doctor on the AR device that is overlapped with the target object seen by the user through the AR device, and even if the AR device or the target object moves, the 3D reconstructed image on the AR device can be adjusted in a real-time fashion, thus greatly improving the accuracy and the efficiency of the doctor during the surgery.

The disclosure has been described in a flow chart and/or a block diagram of the method, the device (system) and the computer program product according to the embodiments of the disclosure. It shall be understood that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor, a Field Programmable Gate Array (FPGA), an Application Specific Integrated Circuit (ASIC), or a processor of another data processing device operating in software or hardware or both to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A method for positioning navigation in a human body by means of augmented reality based upon a real-time feedback, the method comprises:
generating an initial 3D reconstructed image of a target object according to medical image data corresponding to properties of the target object;
adjusting the initial 3D reconstructed image according to a medical database system, and/or a first set of user instructions given by a user to obtain a first 3D reconstructed image of the target object;
generating image transformation parameters according to information extracted from feature points from the target object acquired by an Augmented Reality (AR) device, and the first 3D reconstructed image of the target object, and the AR device is transparent, and can permit the user to see the target object through the AR device; and
adjusting the first 3D reconstructed image according to the image transformation parameters to obtain a second 3D reconstructed image, wherein feature points in the second 3D reconstructed image displayed on the AR device are overlapped with physical feature points of the target object seen by the user through the AR device.

2. The method according to claim 1, wherein the generating the image transformation parameters according to the information extracted from feature points from the target object acquired by the AR device, and the first 3D reconstructed image of the target object comprises:
determining a feature pattern of the target object according to the information extracted from feature points;
determining a rotational angle, a rotational orientation, a translational distance, and a scaling factor of the first 3D reconstructed image according to the feature pattern of the target object, and the first 3D reconstructed image of the target object; and
determining the rotational angle, the rotational orientation, the translational distance, and the scaling factor as the image transformation parameters.

3. The method according to claim 1, wherein before the generating the image transformation parameters according to the information extracted from feature points from the target object acquired by the AR device, and the first 3D reconstructed image of the target object, the method further comprises:
receiving the information extracted from feature points from the target object acquired by the AR device; and
after the adjusting the first 3D reconstructed image according to the image transformation parameters to obtain the second 3D reconstructed image, the method further comprises:
transmitting the second 3D reconstructed image to the AR device, so that the second 3D reconstructed image is displayed on the AR device.

4. The method according to claim 1, wherein the AR device scans the target object using sensors on the AR device to acquire the information extracted from feature points from the target object, wherein the information extracted from feature points is information corresponding to feature markers; or
the AR device acquires the information extracted from feature points from the target object by photographing the target object using a camera on the AR device, wherein the information extracted from feature points is information corresponding to preset locations on the target object.

5. The method according to claim 2, wherein the AR device scans the target object using sensors on the AR device to acquire the information extracted from feature points from the target object, wherein the information extracted from feature points is information corresponding to feature markers; or
the AR device acquires the information extracted from feature points from the target object by photographing the target object using a camera on the AR device, wherein the information extracted from feature points is information corresponding to preset locations on the target object.

6. The method according to claim 1, wherein the method further comprises:
generating image adjustment parameters according to a second set of user instructions;
adjusting the second 3D reconstructed image according to the image adjustment parameter to obtain a third 3D reconstructed image; and
displaying the third 3D reconstructed image on the AR device.

7. The method according to claim 2, wherein the method further comprises:
generating image adjustment parameters according to a second set of user instructions;
adjusting the second 3D reconstructed image according to the image adjustment parameter to obtain a third 3D reconstructed image; and
displaying the third 3D reconstructed image on the AR device.

8. The method according to claim 1, wherein the adjusting the initial 3D reconstructed image according to the medical database system, and/or the first set of user instructions to obtain the first 3D reconstructed image of the target object comprises:
receiving a first parameter adjustment instruction given by the user through a preset parameter adjusting system configured to visually display 3D reconstructed image information; and
adjusting the initial 3D reconstructed image according to the first parameter adjustment instruction to obtain the first 3D reconstructed image of the target object, or
adjusting the initial 3D reconstructed image according to the first parameter adjustment instruction and the medical database system and/or the first set of user instructions to obtain the first 3D reconstructed image of the target object.

9. The method according to claim 1, wherein the adjusting the initial 3D reconstructed image according to the medical database system, and/or the first set of user instructions to obtain the first 3D reconstructed image of the target object comprises:
determining a second parameter adjustment instruction according to function blocks selected by the user from a pre-created library of function blocks, and a mode they connect established by the user for the selected function blocks, wherein each function block in the pre-created library of function blocks is configured to implement an image processing method, or a combination of image processing methods, and all the function blocks in the pre-created library of function blocks can be connected under some pre-defined rules; the image processing method comprises at least one of image processing, pattern recognition, computer vision and all processing that can be manipulated upon image and/or image sequences; and
adjusting the initial 3D reconstructed image according to the second parameter adjustment instruction to obtain the first 3D reconstructed image of the target object, or
adjusting the initial 3D reconstructed image according to the second parameter adjustment instruction and the medical database system and/or the first set of user instructions to obtain the first 3D reconstructed image of the target object.

10. The method according to claim 1, wherein the generating the initial 3D reconstructed image of the target object according to the medical image data comprises:
generating the initial 3D reconstructed image of the target object according to the medical image data, function blocks selected by the user from a pre-created library of function blocks, and a mode they connect established by the user for the selected function blocks, wherein each function block in the pre-created library of function blocks is configured to implement an image processing method, or a combination of image processing methods, and all the function blocks in the pre-created library of function blocks can be connected under some pre-defined rules; the image processing method comprises at least one of image processing, pattern recognition, computer vision and all processing that can be manipulated upon image and/or image sequences;
the adjusting the initial 3D reconstructed image according to the medical database system, and/or the first set of user instructions to obtain the first 3D reconstructed image of the target object comprises:
obtaining a third parameter adjustment instruction according to the first set of user instructions to selected function blocks; and
adjusting the initial 3D reconstructed image according to the third parameter adjustment instruction to obtain the first 3D reconstructed image of the target object, or
adjusting the initial 3D reconstructed image according to the third parameter adjustment instruction and the medical database system and/or the first set of user instructions to obtain the first 3D reconstructed image of the target object.

11. An apparatus for positioning navigation in a human body by means of augmented reality based upon a real-time feedback, the apparatus comprises:
an image generating unit configured to generate an initial 3D reconstructed image of a target object according to medical image data corresponding to properties of the target object; and to adjust the initial 3D reconstructed image according to a medical database system, and/or a first set of user instructions given by a user to obtain a first 3D reconstructed image of the target object;
an image-transformation-parameter generating unit configured to generate image transformation parameters according to information extracted from feature points from the target object acquired by an Augmented Reality (AR) device, and the first 3D reconstructed image of the target object, and the AR device is transparent, and can permit the user to see the target object through the AR device; and
an adjusting unit configured to adjust the first 3D reconstructed image according to the image transformation parameters to obtain a second 3D reconstructed image, wherein feature points in the second 3D reconstructed image displayed on the AR device are overlapped with physical feature points of the target object seen by the user through the AR device.

12. The apparatus according to claim 11, wherein the image transformation parameter generating unit is configured to:
determine a feature pattern of the target object according to the information extracted from feature points;
determine a rotational angle, a rotational orientation, a translational distance, and a scaling factor of the first 3D reconstructed image according to the feature pattern of the target object, and the first 3D reconstructed image of the target object; and
determine the rotational angle, the rotational orientation, the translational distance, and the scaling factor as the image transformation parameters.

13. The apparatus according to claim 11, wherein the apparatus further comprises a receiving unit configured to:
receive the information extracted from feature points from the target object acquired by the AR device; and
the apparatus further comprises a transmitting unit configured to:
transmit the second 3D reconstructed image to the AR device, so that the second 3D reconstructed image is displayed on the AR device.

14. The apparatus according to claim 11, wherein the AR device scans the target object using sensors on the AR device to acquire the information extracted from feature points from the target object, wherein the information extracted from feature points is information corresponding to feature markers; or
the AR device acquires the information extracted from feature points from the target object by photographing the target object using a camera on the AR device, wherein the information extracted from feature points is information corresponding to preset locations on the target object.

15. The apparatus according to claim 12, wherein the AR device scans the target object using sensors on the AR device to acquire the information extracted from feature points from the target object, wherein the information extracted from feature points is information corresponding to feature markers; or
the AR device acquires the information extracted from feature points from the target object by photographing the target object using a camera on the AR device, wherein the information extracted from feature points is information corresponding to preset locations on the target object.

16. The apparatus according to claim 11, wherein the image transformation-parameter-generating unit is further configured to generate image adjustment parameters according to a second set of user instructions;
the adjusting unit is further configured to adjust the second 3D reconstructed image according to the image adjustment parameter to obtain a third 3D reconstructed image; and
the apparatus further comprises a displaying unit configured to display the third 3D reconstructed image on the AR device.

17. The apparatus according to claim 12, wherein the image-transformation-parameter generating unit is further configured to generate image adjustment parameters according to a second set of user instructions;
the adjusting unit is further configured to adjust the second 3D reconstructed image according to the image adjustment parameter to obtain a third 3D reconstructed image; and
the apparatus further comprises a displaying unit configured to display the third 3D reconstructed image on the AR device.

18. The apparatus according to claim 11, wherein the image generating unit is configured to:
receive a first parameter adjustment instruction given by the user through a preset parameter adjusting system configured to visually display 3D reconstructed image information; and
adjust the initial 3D reconstructed image according to the first parameter adjustment instruction to obtain the first 3D reconstructed image of the target object, or
adjust the initial 3D reconstructed image according to the first parameter adjustment instruction and the medical database system and/or the first set of user instructions to obtain the first 3D reconstructed image of the target object.

19. The apparatus according to claim 11, wherein the image generating unit is configured to:
determine a second parameter adjustment instruction according to function blocks selected by the user from a pre-created library of function blocks, and a mode they connect established by the user for the selected function blocks, wherein each function block in the pre-created library of function blocks is configured to implement an image processing method, or a combination of image processing methods, and all the function blocks in the pre-created library of function blocks can be connected under some pre-defined rules; the image processing method comprises at least one of image processing, pattern recognition, computer vision and all processing that can be manipulated upon image and/or image sequences; and
adjust the initial 3D reconstructed image according to the second parameter adjustment instruction to obtain the first 3D reconstructed image of the target object, or
adjust the initial 3D reconstructed image according to the second parameter adjustment instruction and the medical database system and/or the first set of user instructions to obtain the first 3D reconstructed image of the target object.

20. The apparatus according to claim 11, wherein the image generating unit is configured to:
generate the initial 3D reconstructed image of the target object according to the medical image data, function blocks selected by the user from a pre-created library of function blocks, and a mode they connect established by the user for the selected function blocks, wherein each function block in the pre-created library of function blocks is configured to implement an image processing method, or a combination of image processing methods, and all the function blocks in the pre-created library of function blocks can be connected under some pre-defined rules; the image processing method comprises at least one of image processing, pattern recognition, computer vision and all processing that can be manipulated upon image and/or image sequences;
obtain a third parameter adjustment instruction according to a second set of user instructions given by the user to selected function blocks; and
adjust the initial 3D reconstructed image according to the third parameter adjustment instruction to obtain the first 3D reconstructed image of the target object, or
adjust the initial 3D reconstructed image according to the third parameter adjustment instruction and the medical database system and/or the first set of user instructions to obtain the first 3D reconstructed image of the target object.
